(19) United States
(12) Patent Application Publication
(10) Pub. No.: US 2023/0315101 A1
(43) Pub. Date: Oct. 5, 2023

(54) MOBILE OBJECT AND CONTROL METHOD THEREFOR

(71) Applicant: HONDA MOTOR CO., LTD., Tokyo (JP)

(72) Inventors: Yuji YASUI, Wako-shi (JP); Misa KOMURO, Wako-shi (JP)

(21) Appl. No.: 18/122,344

(22) Filed: Mar. 16, 2023

(30) Foreign Application Priority Data
Mar. 31, 2022 (JP) 2022-060594

(51) Int. Cl. G05D 1/02

(52) U.S. Cl. CPC G05D 1/0212; G05D 1/0246

(57) ABSTRACT

A mobile object including a sensor configured to detect a target object in surroundings, recognizes and sets a user, based on an output from the sensor; generates a path of the mobile object to follow the user at a first position that is an obliquely rear side of the user in accordance with a movement of the user that has been set and the output from the sensor; and causes the mobile object to travel in accordance with the path that has been generated.

### CROSS-REFERENCE TO RELATED APPLICATION(S)

This application claims priority to and the benefit of Japanese Patent Application No. 2022-060594 filed on Mar. 31, 2022, the entire disclosure of which is incorporated herein by reference.

### BACKGROUND OF THE INVENTION

### Field of the Invention

The present invention relates to a mobile object and a control method therefor.

### Description of the Related Art

Autonomous mobile bodies such as compact mobility vehicles or robots which travel in the vicinity of a user to guide the user to a destination or help the user to carry baggage are known. International Publication No. 2017/115548 proposes a mobile object that travels to an appropriate position for a user, based on information of the user's trunk and legs. In addition, Japanese Patent Laid-Open No. 2021-64214 proposes a robot control system for following a user at an appropriate distance loaded with the user's baggage.

In public places such as shopping malls, stations, and airports, there are areas that are crowded with people or the like. In such places with a crowd of people, it is very useful for a mobile object to support a user by leading or following the user. On the other hand, the places with a crowd of people can be also the places where target objects in the surroundings can be obstacles for a mobile object that supports a predetermined user. Hence, it is desirable to conduct travel control for a mobile object, while considering a target object in the surroundings and a positional relationship with a user to be supported, in addition to movements of the user to be supported.

### SUMMARY OF THE INVENTION

An object of the present invention is to conduct travel control for a mobile object in a more appropriate following position relative to a user in accordance with target objects in the surroundings including the user.

According to one aspect of the present invention, there is provided a mobile object comprising: a sensor configured to detect a target object in surroundings; a setting unit configured to recognize and set a user, based on an output from the sensor; a path generation unit configured to generate a path of the mobile object to follow the user at a first position that is an obliquely rear side of the user in accordance with a movement of the user that has been set by the setting unit and the output from the sensor; and a travel control unit configured to cause the mobile object to travel in accordance with the path that has been generated.

According to another aspect of the present invention, there is provided a control method for a mobile object including a sensor configured to detect a target object in surroundings, the control method comprising: a setting step of recognizing and setting a user, based on an output from the sensor; a path generation step of generating a path of the mobile object to follow the user at a first position that is an obliquely rear side of the user in accordance with a movement of the user that has been set by the setting step and the output from the sensor; and a travel control step of causing the mobile object to travel in accordance with the path that has been generated.

Further features of the present invention will become apparent from the following description of exemplary embodiments (with reference to the attached drawings).

### BRIEF DESCRIPTION OF THE DRAWINGS

FIG. 1 is a diagram illustrating a configuration example of a system;

FIGS. 2A and 2B are diagrams each illustrating a configuration example of a mobile object;

FIG. 3 is a diagram illustrating an example of a detailed configuration of the present system;

FIG. 4 is a diagram for describing a drive mode of the mobile object;

FIG. 5 is a diagram illustrating an overview of services of the present system;

FIG. 6 is a flowchart illustrating a processing procedure for controlling a path of the mobile object;

FIG. 7 is a flowchart illustrating a processing procedure for generating the path of the mobile object;

FIG. 8 is a diagram illustrating a positional relationship between the mobile object and a user;

FIGS. 9A and 9B are diagrams each illustrating an example of the positional relationship between the mobile object and the user in accordance with a surrounding environment; and

FIG. 10 is a diagram illustrating an example of the positional relationship between the mobile object and the user in accordance with a surrounding environment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### Configuration Example of System

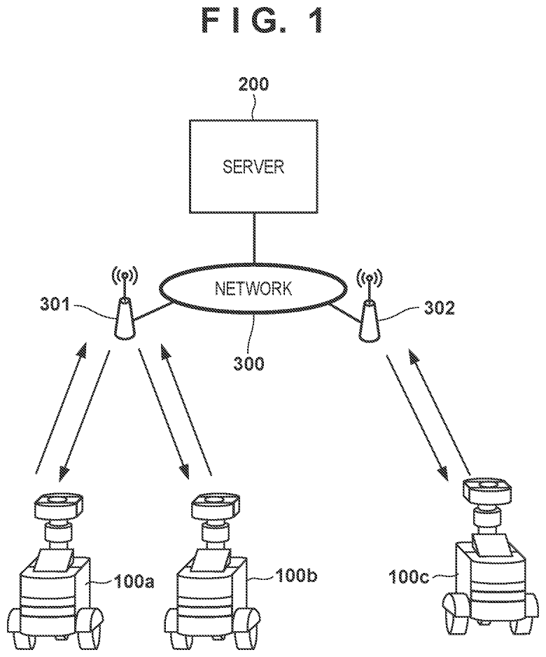

FIG. 1 illustrates a configuration example of a system including a mobile object and a server according to an embodiment of the present invention. The system includes mobile bodies 100a, 100b, and 100c, and a server 200. Since the mobile bodies 100a, 100b, and 100c have similar configurations, the letters at the ends of reference numerals will be omitted in the following description. Note that in a case where a specific mobile object is described, its letter will be added to the end of the reference numeral.

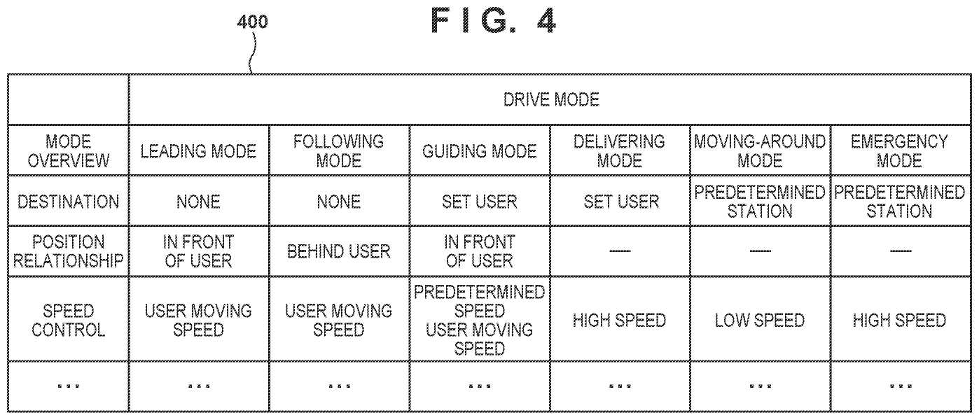

The mobile bodies 100 are arranged in various facilities such as shopping malls, parks, stations, airports, and parking lots, and provides various services to users that have been set (hereinafter, each of such users will be referred to as a “set user”). For example, the mobile object 100 is capable of leading, following, and guiding the set user to be supported, and is capable of making a delivery in response to a request of an authenticated user who has been registered beforehand. The service provided by the mobile object 100 can be changed in accordance with a drive mode of the mobile object, and the drive mode will be described later with reference to FIG. 4. Note that the set user indicates a user whose user confirmation has been conducted by a vein sensor, to be described later, provided in the mobile object 100. In addition, there is no intention of limiting the mobile object in the present invention to the mobile object illustrated in FIG. 1. The present invention is applicable to various mobile bodies, such as four-wheeled vehicles, two-wheeled vehicles, compact mobility vehicles, and robots.

The server 200 monitors a plurality of mobile bodies 100, causes the mobile bodies to move to the respective areas to enhance convenience of users, and controls their arrangement positions and the like. Specifically, the server 200 causes the plurality of mobile bodies 100 to move to locations where the probability that the mobile bodies to be used is higher in areas of a building or the like in which the plurality of mobile bodies 100 are arranged. For example, control is conducted such that the mobile object is caused to move to the vicinity of the location where a crowd of people are present, and the number of mobile bodies 100 in the area is increased in accordance with how crowded it is. In addition, in registering a user, the server 200 may acquire information of the user's veins or the like from the mobile object 100, and may register and authenticate the user. Note that whether the authentication via the server 200 is necessary may be determined separately in accordance with the drive mode of the mobile object 100 used by the user. For example, in a case of using in a delivering mode, only the user that has been registered beforehand via the server 200 may be authenticated. On the other hand, in leading, following, and guiding modes, users do not have to be registered beforehand. A user may be allowed to use only by setting the user itself with the mobile object 100. Identification information that has been acquired (vein information, feature information by use of a captured image, and the like) is used for confirmation processing (re-authentication), when, for example, the user and the mobile object 100 are separated from each other by a predetermined distance or more, that is, when the mobile object 100 loses the user and then the mobile object later finds the user again.

The mobile object 100 and the server 200 are capable of communicating bidirectionally through a network 300. More specifically, the mobile object 100 accesses the network 300 via an access point 301 or 302 in the vicinity, and is thereby enabled to bidirectionally communicate with the server 200 through the network 300. For example, in a case where the mobile object 100 is installed in a building such as a shopping mall or in the premises thereof, the server 200 is capable of identifying a rough position of the mobile object 100 by use of the access point 301 or 302 after it has been accessed by the mobile object 100. That is, the access points 301 and 302 each have position information of the location where it is installed, and it is possible to identify a rough position of the mobile object 100 in accordance with the position information. Further, according to the position information of the access point, it is possible to easily recognize on which floor in the building the mobile object 100 is located (altitude information). Furthermore, the server 200 is capable of identifying a detailed position by use of position information output from a GNSS, to be described later, or the like and provided in the mobile object 100. In addition, by combining this information, the server 200 is capable of acquiring position information of the mobile object 100, which is an object, and which is located in the vicinity of an elevator of an underground parking lot, for example. When the position information output from the GNSS includes altitude information, the altitude information may be used, instead of the position information of the access point.

<Configuration of Mobile object>

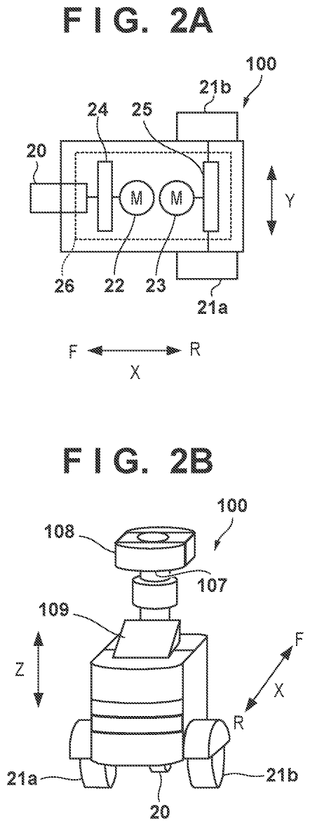

Next, a configuration example of the mobile object 100 according to the present embodiment will be described with reference to FIGS. 2A and 2B. FIG. 2A illustrates an internal configuration of the mobile object 100, and FIG. 2B illustrates a back surface of the mobile object 100 according to the present embodiment. In the drawing, an arrow X indicates a front-and-rear direction of the mobile object 100, and F indicates the front, and R indicates the rear. Arrows Y and Z respectively indicate a width direction (a left-and-right direction) and a vertical direction of the mobile object 100. Since the mobile bodies 100a, 100b, and 100c have similar configurations, letters at the ends of reference numerals will be omitted in the following description.

As illustrated in FIG. 2A, the mobile object 100 includes, as a traveling unit, a front wheel 20, rear wheels 21a and 21b, motors 22 and 23, a steering mechanism 24, a drive mechanism 25, and a housing unit 26. The steering mechanism 24 is a mechanism that changes the steering angle of the front wheel 20 with the motor 22 used as a drive source. By changing the steering angle of the front wheel 20, it is possible to change the advancing direction of the mobile object 100. The drive mechanism 25 is a mechanism that rotates the pair of rear wheels 21a and 21b with the motor 23 used as a drive source. By rotating the pair of rear wheels 21a and 21b, it is possible to cause the mobile object 100 to move forward or backward.

In addition, the mobile object 100 is an electrically autonomous mobile object with a battery 106, to be described later, used as a main power supply. The traveling unit corresponds to a three-wheeled vehicle including the front wheel 20 and the pair of left and right rear wheels 21a and 21b. The traveling unit may be in another form, such as a four-wheeled vehicle. In addition, a seat, not illustrated, can be provided in the mobile object 100.

The housing unit 26 indicates a space in which user's baggage or the like can be loaded. When vein authentication is conducted by a vein sensor 107, to be described later, and user setting is conducted, the lock of a door (not illustrated) of the housing unit 26 is released, and the user is able to load baggage. Then, after a predetermined time elapses or when the set user moves away from the mobile object 100, the door is locked. By conducting the vein authentication for the user again, it is possible to unlock the door. Therefore, the vein information of the set user is held in a memory or the like provided in the mobile object 100.

As illustrated in FIG. 2B, the mobile object 100 further includes the vein sensor 107, a detection unit 108, and an operation panel 109. The vein sensor 107 is a sensor that is provided to face downward below the detection unit 108, and detects the vein of the user's hand inserted into its detection range. By inserting the user's hand into below the vein sensor 107, the user is able to make user settings with the mobile object 100. By notifying the server 200 of the vein information of the set user that has been acquired by the vein sensor 107, it is also possible to conduct user registration. The user that has been registered as a user in the server 200 is able to use more drive modes of the mobile object 100.

The detection unit 108 is a 360-degree camera, and is capable of acquiring an image of 360 degrees in the horizontal direction at a time with the mobile object 100 as the center. Note that there is no intention of limiting the present embodiment, but for example, a camera, in which the detection unit 108 is provided to be rotatable in the horizontal direction, and images captured in a plurality of directions are combined to acquire an image of 360 degrees, may be adopted. As another configuration, a plurality of detection units may be provided to capture images in respectively different directions and analyze individual images. By analyzing a 360-degree image that has been captured by the detection unit 108, the mobile object 100 is capable of detecting a target object, such as a human or an object in the surroundings of the mobile object 100.

The operation panel 109 is a liquid crystal display of a touch panel type having a display unit and an operation unit. In the present invention, the display unit and the operation unit may be configured to be provided individually. The operation panel 109 displays various types of information such as a setting screen for setting the drive mode of the mobile object 100 and map information for giving current position information and the like to the user.

<Detailed Configuration of System>

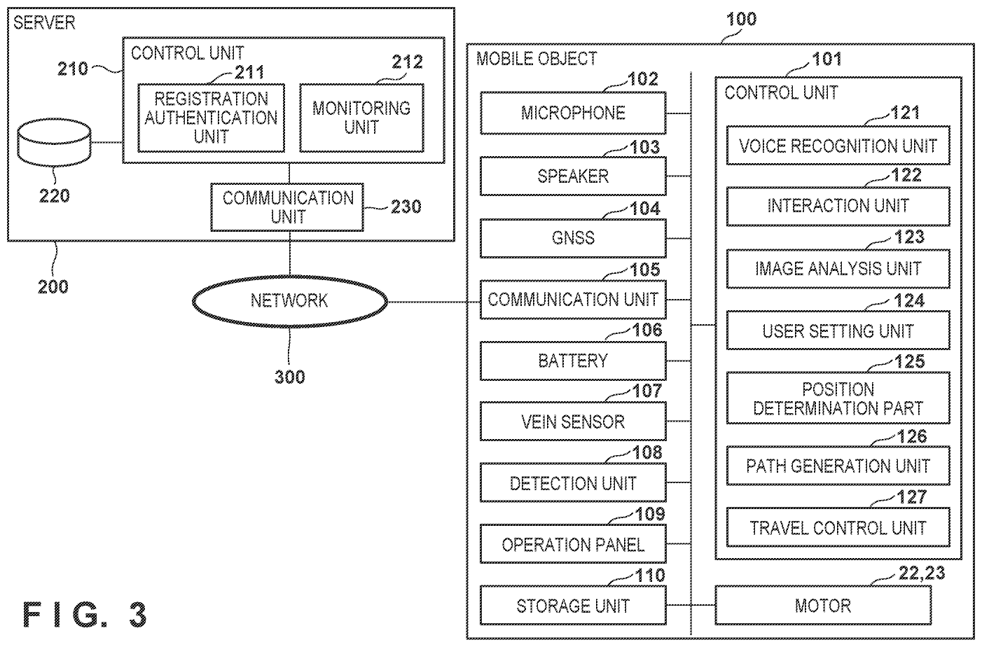

A detailed configuration of each apparatus included in the present system will be described with reference to FIG. 3. Here, a configuration of each apparatus will be described, but the configuration necessary for describing the present invention will be mainly described, and the descriptions of other configurations will be omitted. That is, the configuration of each apparatus in the present invention is not limited to the configuration to be described below, and an additional configuration or an alternative configuration is not excluded.

The server 200 serves as an information processing apparatus such as a personal computer, and includes a control unit 210, a storage unit 220, and a communication unit 230. The control unit 210 includes a registration authentication unit 211 and a monitoring unit 212. By reading and executing a control program stored in the storage unit 220, the control unit 210 achieves various processes. In addition to the above control program, the storage unit 220 stores various data, setting values, registration information of users, and the like. The registration information of users includes authentication information including vein information and feature information of the users. The communication unit 230 controls communication with the mobile object 100 through the network 300.

The registration authentication unit 211 registers users, and authenticates the users that have been registered beforehand. The user registration may be conducted via the mobile object 100, or may be conducted by another device, such as a smartphone or a PC. In a case where the user registration is conducted via the mobile object 100, the vein information that has been acquired as the authentication information by the vein sensor 107 and the feature information of the user that has been extracted from the image acquired by the detection unit 108 are registered in association with the identification information of the user. In addition, the authentication information may include information of a password that has been set by the user. For the identification information, a user's name, a registration number, or the like can be used.

The monitoring unit 212 monitors a plurality of mobile bodies 100 arranged in a predetermined area, and controls a standby position, a move-around area, and the like of the mobile object 100 in accordance with a situation of a facility or the like where the plurality of mobile bodies 100 are arranged. Regarding the situation of the facility where the plurality of mobile bodies 100 are arranged, for example, the degree of the crowdedness may be acquired by conducting an image analysis on a captured image from each mobile object 100. In such a case, for example, an image that has been captured by the mobile object 100 in a moving-around mode is transmitted to the server 200, and is used. The standby position is provided at a predetermined place, and denotes a position where the mobile object 100 with no user setting stops. Note that even in a case where the user setting has been made, it is possible to temporarily stop at the standby position. For example, when the set user enters a place where the mobile object 100 is not capable of entering together, the mobile object 100 can wait at a standby position in the vicinity until the set user conducts re-authentication. In addition, the move-around area indicates an area where the mobile object 100 with no user setting moves around in the moving-around mode to be described later. The monitoring unit 212 monitors the positions of the plurality of mobile bodies 100, and for example, causes the mobile object 100 waiting on standby in the vicinity of a place where there are not many people to move to the vicinity of a place where many people are gathered. Accordingly, a more highly convenient system can be provided. Further, the monitoring unit 212 may grasp the battery remaining amount of each mobile object 100, and may plan a schedule for charging each mobile object 100 for efficient charging at a charging station.

The mobile object 100 includes a control unit 101, a microphone 102, a speaker 103, a GNSS 104, a communication unit 105, a battery 106, and a storage unit 110, in addition to the configuration described with reference to FIGS. 2A and 2B. These components, the motors 22 and 23, the vein sensor 107, the detection unit 108, and the operation panel 109 are connected to be capable of transmitting signals to one another through a system bus or the like. Note that in the following description, the descriptions for the components that has been already described with reference to FIGS. 2A and 2B will be omitted.

The control unit 101, such as an electronic control unit (ECU), controls each device connected by a signal line. By reading and executing a program stored in the storage unit 110, the control unit 101 performs various processes. In addition to the control program, the storage unit 110 includes an area for storing various data, setting values, and the like, and a work area for the control unit 101. Note that the storage unit 110 does not have to be configured with a single device, and can be configured to include at least one of memory devices that are ROM, RAM, HDD, and SDD, for example.

The operation panel 109 denotes a device including an operation unit and a display unit, and may be achieved by, for example, a liquid crystal display of a touch panel type. In addition, the operation unit and the display unit may be individually provided. Various operation screens, map information, notification information to the user, inquiry information, and the like are displayed on the operation panel 109. Further, in addition to the operation panel 109, the mobile object 100 is capable of interacting with the user via the microphone 102 and the speaker 103.

A global navigation satellite system (GNSS) 104 receives a GNSS signal, and detects the current position of the mobile object 100. The communication unit 105 accesses the network 300 through the access point 301 or 302, and bidirectionally communicates with the server 200, which is an external apparatus. The battery 106 is, for example, a secondary battery such as a lithium ion battery, and the mobile object 100 is capable of traveling by itself on the above traveling unit with electric power supplied from the battery 106. In addition, the electric power from the battery 106 is supplied to each load.

A control configuration of the control unit 101 will be described. The control unit 101 includes, as the control configuration, a voice recognition unit 121, an interaction unit 122, an image analysis unit 123, a user setting unit 124, a position determination unit 125, a path generation unit 126, and a travel control unit 127. The voice recognition unit 121 receives sounds in the surroundings of the mobile object 100 through the microphone 102, and recognizes and interprets, for example, a voice from the user. In interacting with the user by voice, the interaction unit 122 generates a question or an answer, and causes the question or the answer to be output by sounds of voice through the speaker 103. Note that regarding the interaction with the user, conversations of the user that has been subjected to voice recognition, and an answer, a question, a warning, and the like from the mobile object 100 may be displayed on the operation panel 109 in accordance with a voice output or voice recognition.

The image analysis unit 123 analyzes an image that has been captured by the 360-degree camera that is the detection unit 108. Specifically, the image analysis unit 123 recognizes a target object including a human or an object from the captured image, and analyzes the image to extract a feature of the user. The feature of the user includes, for example, various features such as a color of clothes, baggage, and a behavioral habit.

The user setting unit 124 sets a user who uses the mobile object 100. Specifically, the user setting unit 124 sets the user by storing the vein information of the user that has been acquired by the vein sensor 107, in the storage unit 110. In addition, the user setting unit 124 may store the feature information of the set user that has been extracted by the image analysis unit 123 in association with the above vein information. The vein information and the feature information stored in the storage unit 110 are used for reconfirming the user, when the user is lost, after the user is set by the user setting unit 124. Here, “lost” denotes that the sight of the set user is lost for a predetermined time or more. When the user is lost, the mobile object 100 moves to, for example, a place in the vicinity where the mobile object 100 can stop, temporarily stops, and waits on standby until the vein sensor 107 or the detection unit 108 confirms the set user.

The position determination unit 125 determines a position relative to the set user, as a position where the mobile object 100 travels. For example, when following the user, the position determination unit 125 determines at which position relative to the set user the mobile object 100 should follow the set user in accordance with the information of a movement of the user and a surrounding environment. The following position is desirably a position from which it is easy for the user to recognize the mobile object 100 and it is less likely to come into contact with an obstacle including anyone in the surroundings. Details of the control for determining the following position will be described later.

The path generation unit 126 generates a path along which the mobile object 100 moves in accordance with the current drive mode of the mobile object 100. The generation of the path here is not a path to the destination but a path for a short distance, for example, five meters or so. Therefore, the path generation unit 126 repeatedly generates a path until the mobile object 100 reaches a destination or the user stops. In addition, when the user deviates from the path, the generated path is modified in accordance with a user's movement. Further, the path generation unit 126 predicts a movement of the set user from an analysis result of the image analysis unit 123 that has analyzed the captured image captured by the detection unit 108, and generates a path to maintain the following position and to avoid a target object that can be an obstacle. Details of path generation will be described later.

The travel control unit 127 controls traveling of the mobile object 100 to maintain the following position in accordance with the path that has been generated by the path generation unit 126. Specifically, the travel control unit 127 causes the mobile object 100 to move along the generated path, and controls its movement while adjusting the positional relationship with the set user by use of the captured image of the detection unit 108. For example, when they are separated from each other by a predetermined distance or more, the speed is increased, or when the set user deviates to the left from the path, the mobile object 100 similarly moves to the left to maintain the following position. As described above, when the set user completely deviates from the path, a path is regenerated.

<Drive Mode>

Next, a drive mode of the mobile object 100 according to the present embodiment will be described with reference to FIG. 4. A table 400 indicated in FIG. 4 illustrates drive modes of the mobile object 100 and features of them. The drive modes to be described below are examples, and there is no intention of excluding any other drive modes.

The mobile object 100 includes, as the drive modes, for example, at least one of a leading mode, a following mode, a guiding mode, a delivering mode, a moving-around mode, and an emergency mode. The leading mode is a mode in which the mobile object 100 is controlled to travel on a forward side of the user in accordance with a moving speed of the user, in a state in which no destination is set. The following mode is a mode in which the mobile object 100 is controlled to travel on a rearward side of the user in accordance with a moving speed of the user in a state in which no destination is set. The guiding mode is a mode in which the mobile object 100 is controlled to travel in accordance with a predetermined speed or a moving speed of the user on a forward side of the user toward a destination in a state in which the destination is set by the user.

The delivering mode is a mode in which the mobile object 100 is controlled to travel at high speed toward a destination in a state in which the destination is set by the user. In addition, the delivering mode is a mode in which any package is loaded on the housing unit 26 so as to be delivered to the destination. The moving-around mode is a mode in which the mobile object 100 is controlled to travel at low speed for heading for a predetermined station (a standby station or a charging station) as a destination. In addition, in the moving-around mode, no user is set, and it is a mode of searching for a user. In the moving-around mode, the mobile object 100 travels while monitoring the surrounding environment by the detection unit 108. For example, upon detection of a human approaching the mobile object 100 while raising its hand, the mobile object 100 determines that such a human is a user who desires to use the mobile object 100, moves to a forward side of the user, and then stops. The emergency mode is a mode for controlling the mobile object 100 to travel at high speed for heading for a predetermined station as a destination. The emergency mode is conducted, for example, to cause the mobile object 100 to move to a charging station when the charge amount of the battery 106 becomes lower than a predetermined value, or to deliver the baggage to a lost-and-found station that stores lost articles when the set user forgets the baggage.

<Operation Overview of Present System>

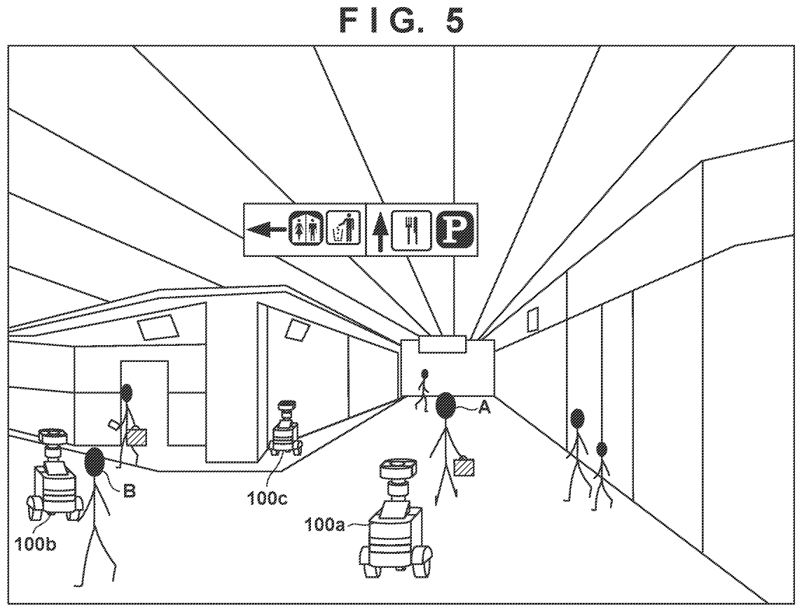

Next, an operation overview of the present system will be described with reference to FIG. 5. The plurality of mobile bodies 100 managed by the server 200 are arranged in various facilities, such as shopping malls, parks, stations, airports, and parking lots. Here, a case where the plurality of mobile bodies 100 are arranged in a shopping mall will be described as an example. In the shopping mall, for example, there are various sites, such as a parking lot, a shop, a restaurant, and a restroom. In addition, according to the present system, stations are also installed, such as a standby station where the mobile object 100 waits on standby, a charging station for charging the mobile object 100, and a lost-and-found station to which a lost article of the user who used the mobile object 100 is delivered. In the present system, in such a facility, various services are provided for the user by the drive modes of the mobile object 100.

For example, as illustrated in FIG. 5, the mobile object 100a provides a set user A with a following service. In addition, the mobile object 100b provides a set user B with a leading service or a guiding service. The mobile object 100c temporarily stops to wait on standby for a set user, not illustrated, who has entered a shop in the vicinity. For example, the mobile object 100 includes map information of the shopping mall in the storage unit 110, and waits on standby at any place in the vicinity, when the set user enters an entry prohibited range that is set in the map information.

Note that in such a facility, there are many objects that obstruct the traveling of the mobile object 100, other than the set user. For example, someone who crosses on a forward side of the set user, someone who passes by the set user, or a signboard in front of a shop may be an obstacle. According to the system in the present embodiment, the system provides various services while avoiding such obstacles that are objects. Hereinafter, from among various services provided by the present system, a following mode service will be described.

<Processing Flow>

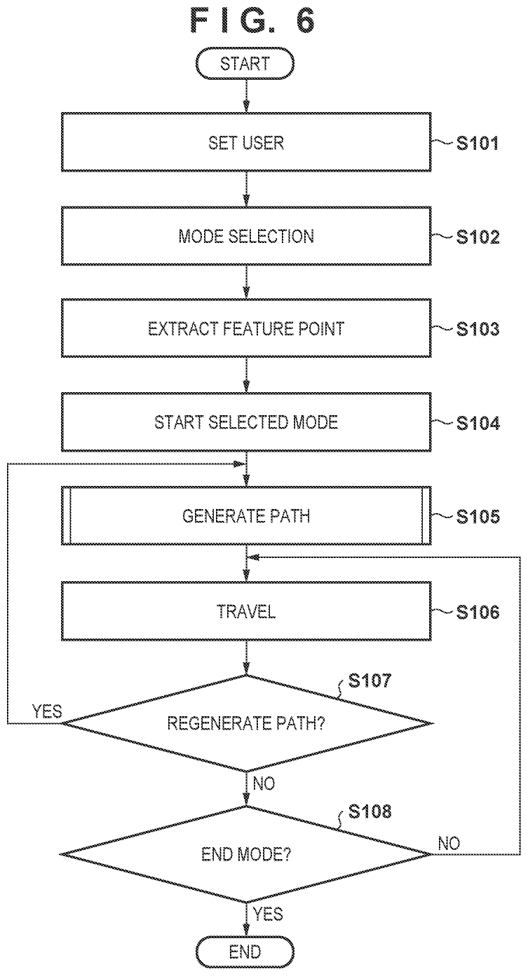

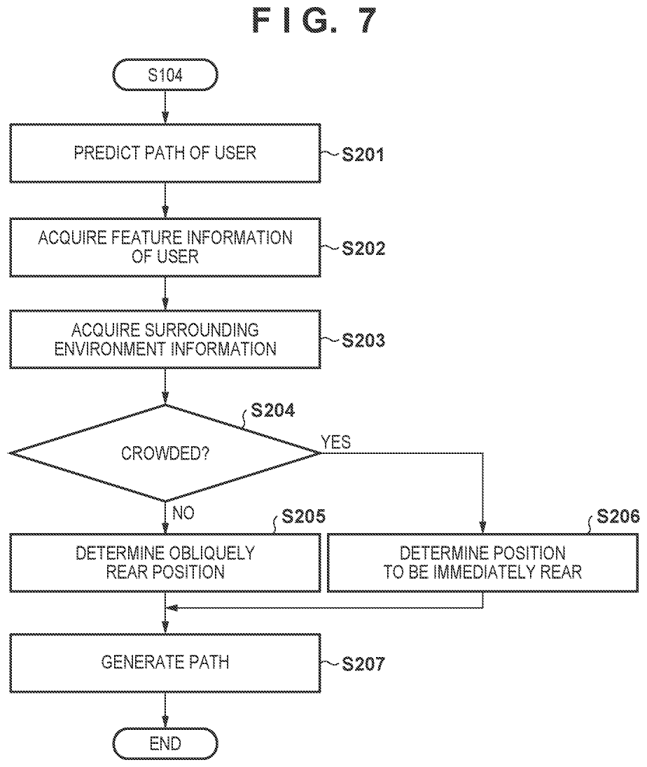

Hereinafter, a processing flow of the following mode in the mobile object according to the present embodiment will be described with reference to FIGS. 6 and 7.

(Following Mode)

First, a processing procedure in the following mode of the mobile object 100 according to the present embodiment will be described with reference to FIG. 6. The processing to be described below is achieved by the CPU of the control unit 101 reading the control program stored in the storage unit 110 into the RAM and executing the control program.

First, in S101, the control unit 101 sets a user. When no user, moving around or stopped, is set, the detection unit 108 in the mobile object 100 conducts an image analysis on a surrounding environment when needed. In such a situation, for example, upon detection of a human approaching the mobile object 100 while raising their hand, the control unit 101 causes the travel control unit 127 to approach the target human and then to stop the mobile object 100. Then, when the human inserts their hand into the detection range of the vein sensor 107, the vein information is acquired. The control unit 101 causes the user setting unit 124 to store the acquired vein information in the storage unit 110 and to set the user as a set user.

Subsequently, in S102, the control unit 101 displays a mode selection screen on the operation panel 109 to prompt the set user to select the drive mode of the mobile object 100. In addition, in S103, the control unit 101 causes the detection unit 108 to capture an image of the set user, and causes the image analysis unit 123 to extract feature points of the user. The extracted features include various features, for example, a color of clothes, baggage, a behavioral habit, and the like. These features are always used for recognizing the user in the case of following the user. Note that S102 and S103 do not have to be performed in this processing order, and may be performed in the reverse order or may be performed in parallel.

Next, in S104, the control unit 101 starts movement control of the mobile object 100 in the drive mode that has been selected by the user via the mode selection screen displayed on the operation panel 109. In the present embodiment, a case where the following mode is selected will be described. When the movement control in the following mode is started, the control unit 101 starts monitoring the movement of the set user in accordance with an analysis result of the image analysis unit 123 that has analyzed a captured image. Specifically, the control unit 101 monitors at least a current position and an orientation of the user, and predicts subsequent moving direction and moving speed of the user. The current position may be acquired, for example, as a relative position by use of a distance from the mobile object 100. The orientation of the user is determined by, for example, an orientation of body (trunk). This is because a human does not always face or look at its moving direction, and the trunk is more likely to be directed in the moving direction than the face or a gaze direction. On the other hand, in a case where the orientation of the trunk is not detectable, the orientation of the face may be used. The moving speed of the user is obtainable based on time-series data related to the current position of the user.

Next, in S105, the control unit 101 causes the position determination unit 125 and the path generation unit 126 to perform path generation processing of the mobile object 100. In the path generation processing, the position of the mobile object 100 (here, the following position) relative to the user is determined, and a path indicating a moving route of the mobile object 100 is further generated. Details of the path generation processing will be described later with reference to FIG. 7. Subsequently, in S106, the control unit 101 causes the travel control unit 127 to control the traveling of the mobile object 100 in accordance with the path that has been generated, while maintaining the mobile object 100 in the following position determined in S105. The travel control unit 127 controls the steering and speed of the mobile object 100 in accordance with the following position and the path.

Next, in S107, the control unit 101 determines whether it is necessary to regenerate a path during traveling. In a case where it is determined that the path has to be regenerated, the processing returns to S105, and in the other cases, the processing proceeds to S108. The case where the path has to be regenerated includes two cases that are a case where the path is modified when the user deviates from the predicted path of the user and a case where a next path is generated when the user approaches within a predetermined distance to an end point of the path of the mobile object 100 generated in S105. The above predicted path of the user denotes a path to be predicted based on the current position of the set user in the path generated in S105, not based on the following position. That is, the control unit 101 does not individually generate the predicted path of the user or the path of the mobile object 100, in the above S105. The control unit 101 generates each path based on one basic path that has been generated, and the following position or the current position of the user. When the set user moves away from the predicted path beyond a predetermined distance, the control unit 101 determines that the set user has deviated from the predicted path.

In S108, the control unit 101 determines whether the current drive mode (here, the following mode) has been ended by the set user. For example, the user is able to give an instruction to end the following mode via the operation panel 109. In addition, the user is able to give an instruction to end the following mode by voice via the microphone 102. In a case where it is determined that the mode has been ended, the processing of the present flowchart is ended, and in the other cases, the processing returns to S106.

(Path Generation Processing)

Subsequently, a detailed processing procedure of the path generation processing (S105) in the following mode of the mobile object 100 according to the present embodiment will be described with reference to FIG. 7. The processing to be described below is achieved by the CPU of the control unit 101 reading the control program stored in the storage unit 110 into the RAM and executing the control program.

First, in S201, the control unit 101 predicts a movement (path) of the set user from the captured image that has been captured by the detection unit 108. Specifically, the control unit 101 acquires a moving direction and a moving speed of the set user from the time-series data, based on monitoring of the current position and the trunk orientation of the set user started in the above S104. Furthermore, the control unit 101 predicts a future path of the set user, based on the moving direction, the moving speed, and the current position that have been acquired. That is, here, the above-described predicted path of the set user is generated.

Subsequently, in S202, the control unit 101 acquires feature information of the user, as information used for following the user. For example, here, information such as a user's behavioral feature or information of an article held by the user is acquired when needed. The acquired information is used for always recognizing the user for following the set user or for determining the following position in following the user. The user's behavioral feature includes, for example, a feature related to the user's look-back behavior, a feature in motions of both arms, and the like. The user's look-back behavior is acquired as feature information indicating which side (right or left) the set user, while moving forward, looks back from more often, when visually recognizing the mobile object 100. This information is used for determining the following position for following the user. In addition, the motions of both arms are acquired as the feature information indicating whether the left arm or and right arm moves more frequently. Further, with regard to the baggage, whether the user is holding the baggage with their left hand or their right hand, whether the baggage is carried on the user's back, or the like is acquired as position information of the baggage. The feature information of the motions of both arms and the position information of the baggage are used for recognizing the user and for determining the following position for following the user.

Next, in S203, the control unit 101 acquires surrounding environment information from the image that has been captured by the detection unit 108. The surrounding environment information denotes information about the set user and a target object in the surroundings of the mobile object 100 included in the captured image. That is, the control unit 101 extracts a target object in a predetermined range in the surroundings from the captured image. In a case where the extracted target object involves a movement, the control unit also predicts the movement. The predetermined range is desirably an area on a forward side of the set user, for example. This is because a path is generated by use of the surrounding environment information, and information of an area to which the set user will move is needed. For example, when a human (target object) who tries to cross a forward area of the user from right to left is acquired as the surrounding environment information, as long as the current following position for following the set user is on a left rear side, it is recognized that there is a possibility of coming into contact with such a human who has crossed from right to left at a location after having moved. Therefore, in order to avoid such contact, it is possible to modify the following position of the mobile object 100 from the left rear side to a right rear side. In changing the following position, such a change is desirably notified to the set user by sounds of voice via the speaker 103.

Next, in S204, the control unit 101 determines whether the above predetermined range is crowded based on the surrounding environment information that has been acquired. In the determination here, for example, in a case where the number of target objects recognized in the surrounding environment information is a predetermined number or more, it may be determined that it is crowded. Alternatively, upon detection of target objects having possibilities of coming into contact with both the left and right sides in a predetermined range on a forward side of the set user, it may be determined that it is crowded. In a case where it is determined that it is crowded, the processing proceeds to S206, and in the other cases, the processing proceeds to S205. In S206, the control unit 101 determines the following position of the mobile object 100 relative to the set user to be located between the left rear side and the right rear side of the set user (second position), and the processing proceeds to S207.

On the other hand, in S205, the control unit 101 determines the following position of the mobile object 100 relative the set user as an obliquely rear position (first position), and the processing proceeds to S207. Furthermore, here, whether it is the left rear side or the right rear side is determined, based on various types of information. The control unit 101 determines the following position from either the left rear side or the right rear side, based on a plurality of references, such as the one from which it is easy to recognize the user, the one in which it is less likely to come into contact with an obstacle such as another target object at a movement destination, and the one that is more preferable for the user. As the one from which it is easy to recognize the user, for example, the one in which many feature points of the user are present or the one in which there are more movements of the user in a predetermined time may be selected. As the one in which it is less likely to come into contact with an obstacle such as another target object at the movement destination, for example, the one having a wider free space where no target object is present in a predetermined range on a forward side may be selected. In addition, as the one that is more preferable for the user, the one in which a more number of times that the user looks back in a predetermined time may be selected.

In S207, the control unit 101 generates the path of the mobile object 100, based on the predicted path of the set user. Specifically, the control unit 101 generates the path of the mobile object 100, based on the above predicted path and the following position that has been determined. When the path is generated, the processing of the present flowchart is ended, and the processing proceeds to S106 of FIG. 6.

<Following Position>

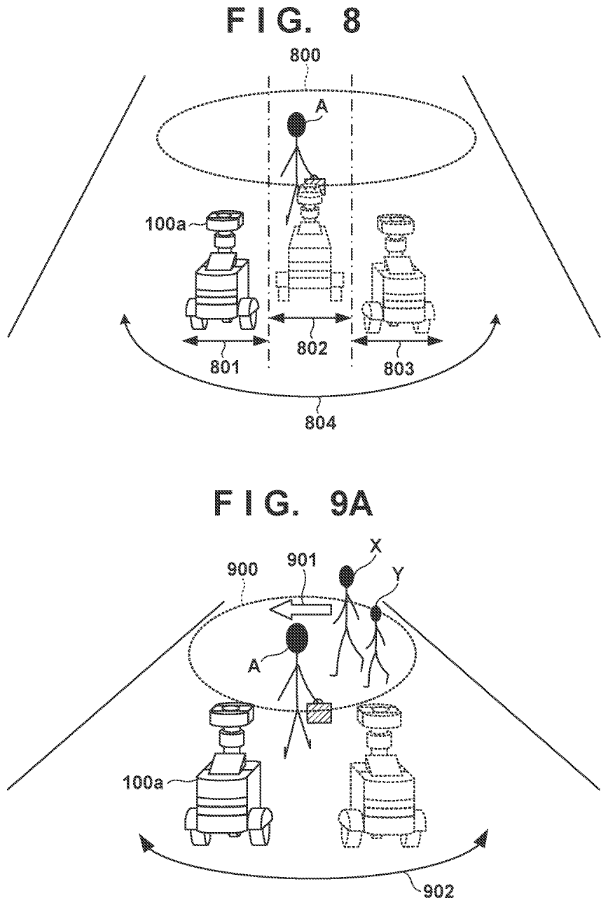

FIG. 8 is a diagram illustrating a following position of the mobile object 100 according to the present embodiment. When following the set user A, the mobile object 100 sets a predetermined position on a rear side of the set user A as the following position.

As illustrated in FIG. 8, the predetermined position on the rear side is divided into three areas to be divided by alternating long and short dash lines with the set user A as the center. That is, the following position is determined to be any one of three positions that are obliquely rear positions (first position) including a left rear side 801 and a right rear side 803 of the user and an immediately rear position 802 (second position) of the user.

As described above, the following position is basically adjusted between the left rear side 801 and the right rear side 803 of the obliquely rear sides of the first position. This is because the mobile object 100 is positioned at a position for the user to easily recognize the mobile object 100, when the user looks back. On the other hand, the immediately rear position 802 becomes a following position to be used when a predetermined range 800 on a forward side of the user is crowded. In this case, the mobile object 100 moves to a position hidden by the set user A, so that the possibility of coming into contact with another target object can be reduced.

Note that in order to acquire the surrounding environment information for the predetermined range 800, a captured image that has been captured by the detection unit 108 of the mobile object 100a that follows the set user A is used. Therefore, in order for the detection unit 108 of the mobile object 100a to acquire the surrounding environment information of the predetermined range 800, there is a possibility that the set user A becomes an obstacle and accurate information is not acquirable. Hence, in acquiring the surrounding environment information, the mobile object 100 according to the present embodiment may move to the left and/or right to capture an image as indicated by an arrow 804 in order to accurately capture an image of the entire area of the predetermined range 800.

### Operation Example

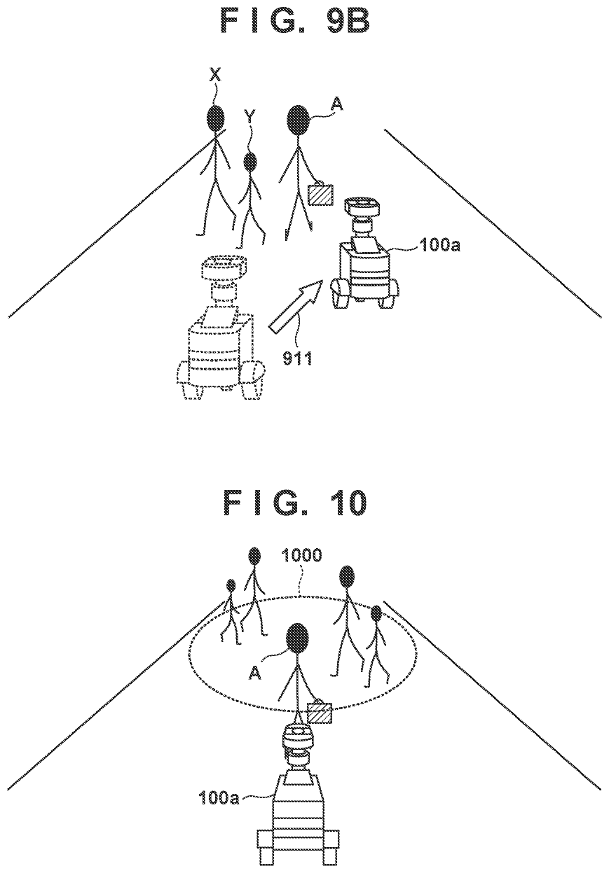

Next, an operation example of the following position according to the present embodiment will be described with reference to FIGS. 9A to 10. First, a case where another target object crosses on a forward side of the set user A will be described with reference to FIGS. 9A and 9B.

As illustrated in FIG. 9A, the mobile object 100a follows the set user A on the left rear side thereof. On the other hand, in a predetermined range 900 on a forward side of the set user A, target objects X and Y that are humans are moving in the direction of an arrow 901. By causing the image analysis unit 123 to analyze the captured image that has been captured by the detection unit 108, the control unit 101 is capable of acquiring the above-described surrounding environment information. Note that when it is impossible to capture an image of a part of the predetermined range 900 because the set user A becomes an obstacle, the mobile object 100a may move to the left and/or right as indicated by an arrow 902 to capture an image. In such a situation, in a case where the left rear side is set to the following position continuously, there is a possibility that the mobile object 100a comes into contact with the target objects X and Y several meters ahead. Therefore, the mobile object 100 changes the following position to reduce such a possibility of contact.

As illustrated in FIG. 9B, the mobile object 100a changes the following position to the right rear side of the set user A, and moves while traveling as indicated by an arrow 911. Accordingly, the mobile object 100 moves to the right rear side of the set user A at the timing when the mobile object passes by the target objects X and Y, so that the possibility of contact can be reduced.

FIG. 10 illustrates a state in which the predetermined range on a forward side of the set user A is crowded. In this case, as illustrated in FIG. 10, the mobile object 100a travels at an immediately rear position of the set user A as the following position. Accordingly, also when passing through a crowded area, it becomes possible to avoid contact with another target object with the set user A functioning like a wall. Further, in a case where the mobile object 100 is located on an immediately rear side, the distance to the set user A is desirably adjusted to be shorter than the case where the mobile object is located on an obliquely rear side. Accordingly, it is possible to avoid contact with further another target object.

### Summary of Embodiments

The above embodiments disclose at least the following embodiments.

1. A mobile object (100) in the above embodiment includes:

a sensor (108) configured to detect a target object in surroundings;

a setting unit (101, 124) configured to recognize and set a user, based on an output from the sensor;

a path generation unit (125, 126, S104) configured to generate a path of the mobile object to follow the user at a first position that is an obliquely rear side of the user in accordance with a movement of the user that has been set by the setting unit and the output from the sensor; and

a travel control unit (127) configured to cause the mobile object to travel in accordance with the path that has been generated.

According to this embodiment, the travel control for the mobile object can be conducted at a more appropriate following position relative to the user in accordance with target objects in the surroundings including the user.

2. In the above embodiment, the first position is either on a left rear side or a right rear side of the user who is moving (801, 803).

According to this embodiment, the position of the mobile object can be adjusted to a position that is preferable for the user or a position for avoiding contact with another target object.

3. In the above embodiment, when the number of target objects detected by the sensor in a surrounding environment where the user moves exceeds a predetermined number, the path generation unit generates the path to follow the user at a second position (802) to be located between the left rear side and the right rear side, instead of the first position.

According to this embodiment, contact with another target object can be avoided by use of the user who is preceding and functioning like a wall, in a crowded situation in the surrounding environment.

4. In the above embodiment, a distance between the second position and the user is shorter than a distance between the first position and the user (802).

According to this embodiment, contact with another target object can be avoided more safely, in a crowded situation in the surrounding environment.

5. In the above embodiment, the path generation unit generates the path to follow the user at a position on either the left rear side or the right rear side of the user where an estimated area of a free space detected by the sensor is largest (S205).

According to this embodiment, it is possible to select the one with fewer obstacles at a movement destination, and to avoid contact with another target object.

6. In the above embodiment, the path generation unit generates the path to follow the user at a rear position on either the left rear side or the right rear side of the user where more recognizable feature points of the user are present, as the first position (S205).

According to this embodiment, it is possible to follow the user at a position from which it is easier to recognize the user.

7. In the above embodiment, the path generation unit generates the path to follow the user at a rear position on either the left rear side or the right rear side of the user where one of user's arms makes more movements recognized in a predetermined time, as the first position (S205).

According to this embodiment, it is possible to follow the user at a position from which it is easier to recognize the user.

8. In the above embodiment, the path generation unit generates the path to follow the user at a rear position on either the left rear side or the right rear side of the user where the user looks back a larger number of times recognized in a predetermined time, as the first position (S205).

According to this embodiment, it is possible to follow the user at a preferable position for the user.

9. In the above embodiment, the travel control unit further adjusts the first position in accordance with the output from the sensor, and conducts travel control for the mobile object (S106).

According to this embodiment, it is possible to easily handle deviation of the user from the predicted path.

10. In the above embodiment, a setting unit (109, S102) configured to set a travel mode related to path control of the mobile object in accordance with a user input is further included, in which

when the setting unit sets a following mode, the path generation unit generates the path to follow the user.

According to this embodiment, various drive modes in the mobile object can be provided.

11. In the above embodiment, the sensor serves as a camera capable of capturing an image at 360 degrees in a horizontal direction (108).

According to this embodiment, a wider range of surrounding images can be acquired at a time, and a processing load can be reduced in following control that necessitates real-time control.

12. In the above embodiment, a control method for a mobile object (100) including a sensor (108) configured to detect a target object in surroundings, the control method includes:

a setting step (S101) of recognizing and setting a user, based on an output from the sensor;

a path generation step (S105) of generating a path of the mobile object to follow the user at a first position that is an obliquely rear side of the user in accordance with a movement of the user that has been set by the setting step and the output from the sensor; and

a travel control step (S107) of causing the mobile object to travel in accordance with the path that has been generated.

According to this embodiment, the travel control for the mobile object can be conducted at a more appropriate following position relative to the user in accordance with target objects in the surroundings including the user.

The invention is not limited to the foregoing embodiments, and various variations/changes are possible within the spirit of the invention.

What is claimed is:

1. A mobile object comprising:
a sensor configured to detect a target object in surroundings;
a setting unit configured to recognize and set a user, based on an output from the sensor;
a path generation unit configured to generate a path of the mobile object to follow the user at a first position that is an obliquely rear side of the user in accordance with a movement of the user that has been set by the setting unit and the output from the sensor; and
a travel control unit configured to cause the mobile object to travel in accordance with the path that has been generated.

2. The mobile object according to claim 1, wherein the first position is either on a left rear side or a right rear side of the user who is moving.

3. The mobile object according to claim 2, wherein, in a case where the number of target objects detected by the sensor in a surrounding environment where the user moves exceeds a predetermined number, the path generation unit generates the path to follow the user at a second position to be located between the left rear side and the right rear side, instead of the first position.

4. The mobile object according to claim 3, wherein a distance between the second position and the user is shorter than a distance between the first position and the user.

5. The mobile object according to claim 3, wherein the path generation unit generates the path to follow the user at a position on either the left rear side or the right rear side where an estimated area of a free space detected by the sensor is largest.

6. The mobile object according to claim 2, wherein the path generation unit generates the path to follow the user at a rear position on either the left rear side or the right rear side of the user where more recognizable feature points of the user are present, as the first position.

7. The mobile object according to claim 2, wherein the path generation unit generates the path to follow the user at a rear position on either the left rear side or the right rear side of the user where one of user's arms makes more movements recognized in a predetermined time, as the first position.

8. The mobile object according to claim 2, wherein the path generation unit generates the path to follow the user at a rear position on either the left rear side or the right rear side of the user where the user looks back a larger number of times recognized in a predetermined time, as the first position.

9. The mobile object according to claim 1, wherein the travel control unit further adjusts the first position in accordance with the output from the sensor, and conducts travel control for the mobile object.

10. The mobile object according to claim 1, further comprising a setting unit configured to set a travel mode related to path control of the mobile object in accordance with a user input, wherein
in a case where the setting unit sets a following mode, the path generation unit generates the path to follow the user.

11. The mobile object according to claim 1, wherein the sensor serves as a camera capable of capturing an image at 360 degrees in a horizontal direction.

12. A control method for a mobile object including a sensor configured to detect a target object in surroundings, the control method comprising:
a setting step of recognizing and setting a user, based on an output from the sensor;
a path generation step of generating a path of the mobile object to follow the user at a first position that is an obliquely rear side of the user in accordance with a movement of the user that has been set by the setting step and the output from the sensor; and
a travel control step of causing the mobile object to travel in accordance with the path that has been generated.
